(19) United States
(12) Patent Application Publication
(10) Pub. No.: US 2006/0070043 A1
(43) Pub. Date: Mar. 30, 2006

(54) System and method for analyzing computer code

(76) Inventors: John T. Viega, Warrenton, VA (US); Matt D. Messier, Manassass, VA (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 11/189,019

(22) Filed: Jul. 26, 2005

Related U.S. Application Data
(60) Provisional application No. 60/591,101, filed on Jul. 27, 2004.

(51) Int. Cl. G06F 9/45

(52) U.S. Cl. 717/136

(57) ABSTRACT

A system and method for analyzing computer code are provided. An original language of a computer code is determined. The original language can be selected from multiple computer languages. The computer code is translated to a generic computer language, which maintains the instructions of the computer code. The generic language is analyzed according to one or more pre-determined rules to determine if any incidents of interest exist within the computer code. The incidents of interest can include, for example, security-related items. If desired, a user can be notified of any incidents of interest.

### FIELD OF THE INVENTION

The invention relates to a system and method for analyzing computer code. More specifically, one or more embodiments of the invention relate to applying various analysis techniques to computer code to determine if any incidents of interest, such as security-related problems, associated with the computer code exist.

### BACKGROUND

Computers and other processor-based devices have become increasingly widespread. Software and firmware for operating computers (i.e., computer code) has become correspondingly widespread and is important in many facets of life. Many people, for example, use computer code with standard computing devices such as personal computers (PCs), workstations, or the like. Computer code used with such computing devices can include, for example, operating systems, application programs, utilities, network communications software, and so forth.

Like standard computing devices, other processor-based devices make use of computer code, in some cases unbeknownst to users. For example, electronic devices, such as digital video disk (DVD) players, digital video recorders (DVRs), stereos, MP3 players, televisions, and other such devices can use a variety of software or computer code to provide different functions. Additionally, an increasing number of appliances use software to perform various functions. For example, devices such as home appliances, air-conditioning systems, automobiles, and other commonly used devices use computer code, extensively in some cases, to provide various types of functionality. Additional examples where computer code plays an important role include medical equipment, facilities controls, and aircraft. In many of these cases, the computer code plays a mission critical role.

In some instances, devices that use computer code can communicate with one another. For example, such devices can be connected to perform network computing or other communications functions using one or more network protocols to intercommunicate. For example, multiple devices can be interconnected by way of a local area network (LAN), a wide area network (WAN), a wireless LAN (WLAN), an optical network, the Internet, or other suitable networks.

Because of society's increasing reliance on standard computing devices and processor-based devices that use computer code, many people have increasing concerns regarding security of that computer code. In other words, as devices we use in our daily lives increasingly use or implement computer code, concerns for the security of that code have also increased. For example, devices that we rely on, such as appliances, automobiles, or the like, can cause safety concerns if the security of the computer code cannot be maintained.

Additionally, as devices become increasingly interconnected, or otherwise are able to receive communications or other inputs from an increasing number of external devices, the concern for a security breach also increases. For example, a security breach would be more likely when poorly written, malicious, or otherwise insecure computer code is implemented on a device, and the number of connections to the device running the insecure computer code increase.

Accordingly, it would be desirable to develop a system and method for analyzing computer code. For example, it would be desirable to develop a system and method for analyzing computer code for incidents of interest, such as security-related issues, or other issues of similar concern.

### SUMMARY

Accordingly, one or more embodiments of the invention provide a system and method for analyzing computer code. For example, according to one or more embodiments of the invention, a system and method for analyzing computer code is capable of recognizing incidents of interest, such as security-related issues, or other issues of concern, and/or notifying a user regarding such incidents or problems.

One or more embodiments of the invention, for example, provide a system including a translator, a knowledge base component, an analysis engine, and a reporting component. The translator is configured to translate code including code from one of multiple computer languages to a generic computer language, which maintains the structure and functionality of the computer code (and, in some cases, the actual instructions or their equivalent). The knowledge base component is configured to store multiple analysis rules associated with analysis of code in the generic computer language. The analysis engine is in communication with the language translator and the knowledge base component, and is configured to analyze code in the generic computer language received from the translator according to one or more rules stored by the knowledge base component. The analysis engine is also configured to output any incidents of interest required by the one or more rules to be reported. The reporting component is in communication with the analysis engine, and is configured to report any incidents of interest output by the analysis engine in a form readily accessible by a user. The incidents of interest can include, for example, security-related items.

One or more other embodiments of the invention provide a method that includes determining an original language of a computer code. The original language can be one or multiple computer languages. The computer code is translated to a generic computer language, which maintains the instructions of the computer code. The generic language is analyzed according to one or more pre-determined rules to determine if any incidents of interest exist within the computer code. The incidents of interest can include, for example, security-related items, and a user can optionally be notified of such incidents of interest, if desired.

Further features of the invention, and the advantages offered thereby, are explained in greater detail hereinafter with reference to specific embodiments described below and illustrated in the accompanying drawings, wherein like elements are indicated by like reference designators.

### BRIEF DESCRIPTION OF THE DRAWINGS

FIG. 1 is a block diagram of a processor system and other devices connected to a network, according to an embodiment of the invention.

FIG. 2 is a block diagram of various types of computer code and components used to translate the instructions, according to an embodiment of the invention.

FIG. 3 is a block diagram illustrating how various types of computer code are created, modified, and run, according to an embodiment of the invention.

FIG. 4 is a block diagram of a system for analyzing computer code, according to an embodiment of the invention.

FIG. 5 is a block diagram of various analyses carried out according to an embodiment of the invention.

FIG. 6 is a flow diagram of a technique for analyzing computer code, according to an embodiment of the invention.

FIG. 7 is a flow diagram of a technique for analyzing computer code, according to an embodiment of the invention.

FIG. 8 is a flow diagram of a technique for analyzing computer code, according to an embodiment of the invention.

### DETAILED DESCRIPTION

According to one or more embodiments of the invention, a system and method for analyzing computer code are provided. The system and method of various embodiments of the invention can be used to analyze computer code for specific incidents of interest, which can include security-related incidents, or other items of concern. Once incidents of interest are identified within the computer code, a user can be notified of their existence, allowing the user to take corrective steps to prevent the identified incident of interest from causing unwanted problems, such as exposing a security-related or other vulnerability.

The term “computer code” as used herein, is intended to encompass instructions configured to cause a processor (e.g., within a computer, a processor system, or other processor-based devices) to perform steps, functions, operations, or calculations. For example, without limitation, “computer code” can include source code, assembly language, machine language, machine code, or any other set of instructions configured to cause a processor to perform steps, functions, operations, or calculations.

According to one or more embodiments of the invention, a variety of types of computer code can be analyzed. For example, low-level computer code, such as machine code, machine language, or assembly language can be analyzed. Additionally, higher-level computer code, such as source code, can be analyzed. Moreover, computer code from a variety of languages can be analyzed according to one or more embodiments of the invention. For example, source code expressed in one or more programming languages can be analyzed according to one or more embodiments of the invention, such as C, C++, formula translator language (Fortran), Java, Pascal, Basic, Visual Basic, common business oriented language (Cobol), and others.

To facilitate analysis of multiple different types of computer code, one or more embodiments can translate computer code received into a generic language. The generic language can be configured to preserve the basic instruction set of the original computer code. Various analyses can then be carried out on the generic language into which the instructions of the computer code have been translated. For example, analysis of aliases, control flow, buffers, ranges, overflows, data flow, entry points, and so forth can be carried out according to predetermined rules. These rules can be stored in a knowledge base component, and can be developed to facilitate the various analysis techniques used on the translated computer code.

As the various analysis techniques are carried out on the translated computer code, various incidents of interest can be noted and/or output according to the predetermined rules. For example, security-related incidents or other items of concern identified within the translated computer code can be noted. Thus, for example, as functions, containers, data, or other elements of the computer code are analyzed and determined to have security-related incidents, or other incidents of interest, associated therewith, according to predetermined rules, those incidents can be recorded, and can optionally be reported to a user for possible correction.

Although many elements associated with the system and method of various embodiments of the invention will be discussed exclusively in the context of either hardware, software, or firmware, many of these elements can also be implemented using any combination of hardware, software, and/or firmware. Additionally, individual elements or steps can be combined, or additional elements or steps can be added, according to the principles of the invention, although not explicitly shown.

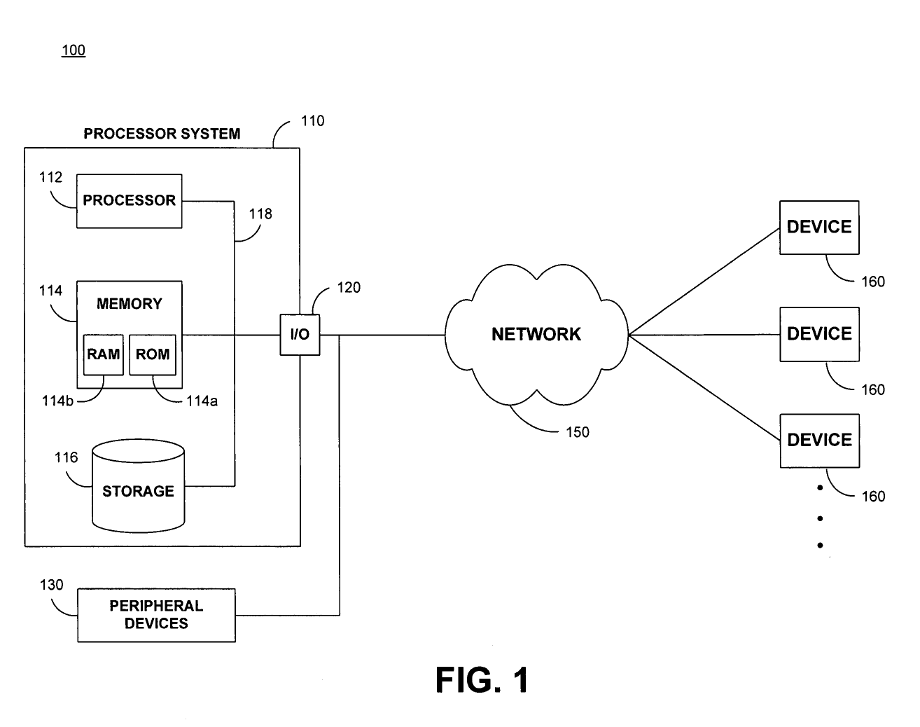

FIG. 1 is a block diagram of a processor system 110 and other devices 160 connected to a network 150, according to an embodiment of the invention. The various elements in FIG. 1 are shown in a network-computing environment 100, wherein a processor system 110 is interconnected with a network 150, by which the processor system 110 and/or multiple other devices 160 can communicate. It will be appreciated that the elements shown in FIG. 1 are examples of components that can be included in such a processor system 110 and/or devices that can be in communication with a processor system 110, and that elements can be removed or additional elements can be added depending upon the desired functionality of such a system. For example, the processor system 110 can function independently of a network 150, or can include more or fewer components than illustrated in FIG. 1.

The processor system 110 illustrated in FIG. 1 can be, for example, a commercially available personal computer (PC), a workstation, a network appliance, a portable electronic device, or a less-complex computing or processing device (e.g., a device that is dedicated to performing one or more specific tasks or other processor-based), or any other device capable of communicating via a network 150. Although each component of the processor system 110 is shown as a single component in FIG. 1, the processor system 110 can include multiple numbers of any components shown in FIG. 1. Additionally, multiple components of the processor system 110 can be combined as a single component, where desired.

The processor system 110 includes a processor 112, which can be a commercially available microprocessor capable of performing general processing operations. For example, the processor 112 can be selected from the 8086 family of central processing units (CPUs) available from Intel Corp. of Santa Clara, Calif., or other similar processors. Alternatively, the processor 112 can be an application-specific integrated circuit (ASIC), or a combination of ASICs, designed to achieve one or more specific functions, or enable one or more specific devices or applications. In yet another alternative, the processor 112 can be an analog or digital circuit, or a combination of multiple circuits.

The processor 112 can optionally include one or more individual sub-processors or coprocessors. For example, the processor 112 can include a graphics coprocessor that is capable of rendering graphics, a math coprocessor that is capable of efficiently performing mathematical calculations, a controller that is capable of controlling one or more devices, a sensor interface that is capable of receiving sensory input from one or more sensing devices, and so forth.

Additionally, the processor system 110 can include a controller (not shown), which can optionally form part of the processor 112, or be external thereto. A controller can, for example, be configured to control one or more devices associated with the processor system 110. For example, a controller can be used to control one or more devices integral to the processor system 110, such as input or output devices, sensors, or other devices. Additionally, or alternatively, a controller can be configured to control one or more devices external to the processor system 110, which can be accessed via an input/output (I/O) component 120 of the processor system 110, such as peripheral devices 130, devices accessed via a network 150, or the like.

The processor system 110 can also include a memory component 114. As shown in FIG. 1, the memory component 114 can include one or more types of memory. For example, the memory component 114 can include a read-only memory (ROM) component 114a and a random-access memory (RAM) component 114b. The memory component 114 can also include other types of memory not illustrated in FIG. 1 that are suitable for storing data in a form retrievable by the processor 112, and are capable of storing data written by the processor 112. For example, erasable programmable read only memory (EPROM), electrically erasable programmable read only memory (EEPROM), flash memory, as well as other suitable forms of memory can be included as part of the memory component 114. The processor 112 is in communication with the memory component 114, and can store data in the memory component 114 or retrieve data previously stored in the memory component 114.

The processor system 110 can also include a storage component 116, which can be one or more of a variety of different types of storage devices. For example, the storage component 116 can be a device similar to the memory component 114 (e.g., EPROM, EEPROM, flash memory, etc.). Additionally, or alternatively, the storage component 116 can be a magnetic storage device (such as a disk drive or a hard-disk drive), compact-disk (CD) drive, database component, or the like. In other words, the storage component 116 can be any type of storage device suitable for storing data in a format accessible to the processor system 110.

The various components of the processor system 110 can communicate with one another via a bus 118, which is capable of carrying instructions from the processor 112 to other components, and which is capable of carrying data between the various components of the processor system 110. Data retrieved from or written to the memory component 114 and/or the storage component 116 can also be communicated via the bus 118.

The processor system 110 and its components can communicate with devices external to the processor system 110 by way of an input/output (I/O) component 120 (accessed via the bus 118). According one or more embodiments of the invention, the I/O component 120 can communicate using a variety of suitable communication interfaces. The I/O component 120 can also include, for example, wireless connections, such as infrared ports, optical ports, Bluetooth wireless ports, wireless LAN ports, or the like. Additionally, the I/O component 120 can include, wired connections, such as standard serial ports, parallel ports, universal serial bus (USB) ports, S-video ports, large area network (LAN) ports, small computer system interface (SCSI) ports, and so forth.

By way of the I/O component 120 the processor system 110 can communicate with devices external to the processor system 110, such as peripheral devices 130 that are local to the processor system 110, or with devices that are remote to the processor system 110 (e.g., via the network 150). The I/O component 120 can be configured to communicate using one or more communications protocols used for communicating with devices, such as the peripheral devices 130. The peripheral devices 130 in communication with the processor system 110 can include any of a number of peripheral devices 130 desirable to be accessed by or used in conjunction with the processor system 110. For example, the peripheral devices 130 with which the processor system 110 can communicate via the I/O component 120, can include a communications component, processor, a memory component, a printer, a scanner, a storage component (e.g., an external disk drive, database, etc.), or any other device desirable to be connected to the processor system 110.

The processor system 110 can communicate with a network 150, such as the Internet or other networks by way of a gateway, a point of presence (POP) (not shown), or other suitable means. Other devices 160 can also access the external network 150. For example, other devices can communicate with the network 150 using a network service provider (NSP), which can be an Internet service provider (ISP), an application service provider (ASP), an email server or host, a bulletin board system (BBS) provider or host, a point of presence (POP), a gateway, a proxy server, or other suitable connection point to such a network 150 for the devices 160.

Because the processor system 110 can be accessible by other devices 160 via the network 150, security concerns regarding the security of the processor system 110 or its components (e.g., hardware or software) can be an issue of concern. Additionally, or alternatively, security concerns can arise through direct use of the processor system 110, without regard to the network 150. For example, a local user, using the processor system 110, who knows of potential weaknesses in software run by the processor 112 of the processor system 110, can attempt to exploit them, creating a security concern. Accordingly, the various embodiments of the invention can be applicable in network environments 100, such as is shown in FIG. 1, or in non-network environments.

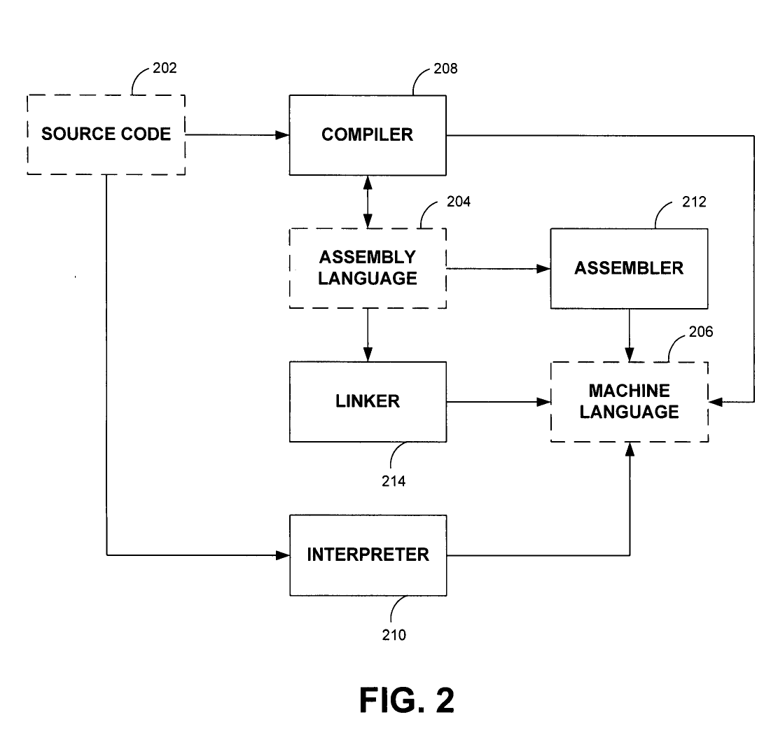

FIG. 2 is a block diagram of various types of computer code and components used to translate the instructions, according to an embodiment of the invention. In FIG. 2, various types of computer code are illustrated, including source code 202, assembly language 204, and machine language 206 (sometimes referred to as machine code). All types of computer code are illustrated with dashed boxes in FIG. 2.

Source code 202 is higher-level computer code that is not directly executable by a computer (e.g., the processor device 110), but must be translated, compiled, interpreted, or otherwise converted prior to execution by the computer. For example, source code 202 can be converted by a compiler 208, an interpreter 210, or an assembler 212, which are described in greater detail below. Generally, source code 202 is written by a programmer, who expresses computer instructions in the form of source code 202. In some instances, however, source code 202 can be generated by a computer, such as when computer code is translated from source code 202 in a first language to source code 202 in a second language. This could include, for example, conversion from the C programming language into assembly language or from assembly language into machine language.

Machine language 206 is lower-level computer code that is directly executable by a computer (e.g., the processor device 110). Machine language 206 includes binary-coded machine instructions specific for the computer on which it is executed. Usually machine language 206 includes both the instructions to be executed by a computer and the locations (e.g., memory addresses) of the data to be operated upon. Although it is possible for programmers to directly create or modify machine language 206, generally machine language 206 is created by a compiler 208, an interpreter 210, an assembler 212, or a linker 214, which are described in greater detail below.

Assembly language 204 is lower-level computer code that is similar to, but generally considered to be higher-level than, machine language 206. Assembly language 204 is hardware-dependent (e.g., there is a different assembly language 206 for each different type of processor 112) and each statement in assembly language 204 generally corresponds to a single instruction in machine language 206. Assembly language 204 differs from machine language 206 in that it does not reference the specific memory addresses of data to be operated upon.

As shown in FIG. 2, a compiler 208 can be used to convert high-level language instructions into lower-level instructions. For example, a compiler 208 can be used to convert source code 202 to assembly language 204 and/or to machine language 206. For example, a compiler 208 can be used to first translate source code 202 into assembly language 204, and then subsequently to translate the assembly language 204 into machine language 206. Alternatively, a compiler 208 can be used to convert source code 202 directly into machine language 206.

Alternatively, an interpreter 210 instead of a compiler 208 can be used with source code 202 that is interpreted (e.g., Java, etc.) rather than compiled. For example, when the source code 202 is to be interpreted, an interpreter 210 can interpret the source code 202 directly into instructions understandable by the computer upon which it is to be executed, such as machine language 206. An interpreter 210 usually interprets and executes instructions in the source code 202 at the same time. In other words, the interpreter 210 usually interprets a statement in the source code 202 into one or more machine language 206 statements, and executes the machine language 206 statements prior to interpreting the next statement in the source code 202.

An assembler 212 can be used to convert assembly language 204 into machine language 206. Alternatively, a linker 214 (also sometimes referred to as a link editor) can be used to link an assembly language program to a particular environment (e.g., a particular operating system, device, etc.). Generally, a linker 214 is a utility program that unites references between program modules and libraries of subroutines, and outputs a load module, which is executable code ready to be executed on a particular device, or within a particular environment.

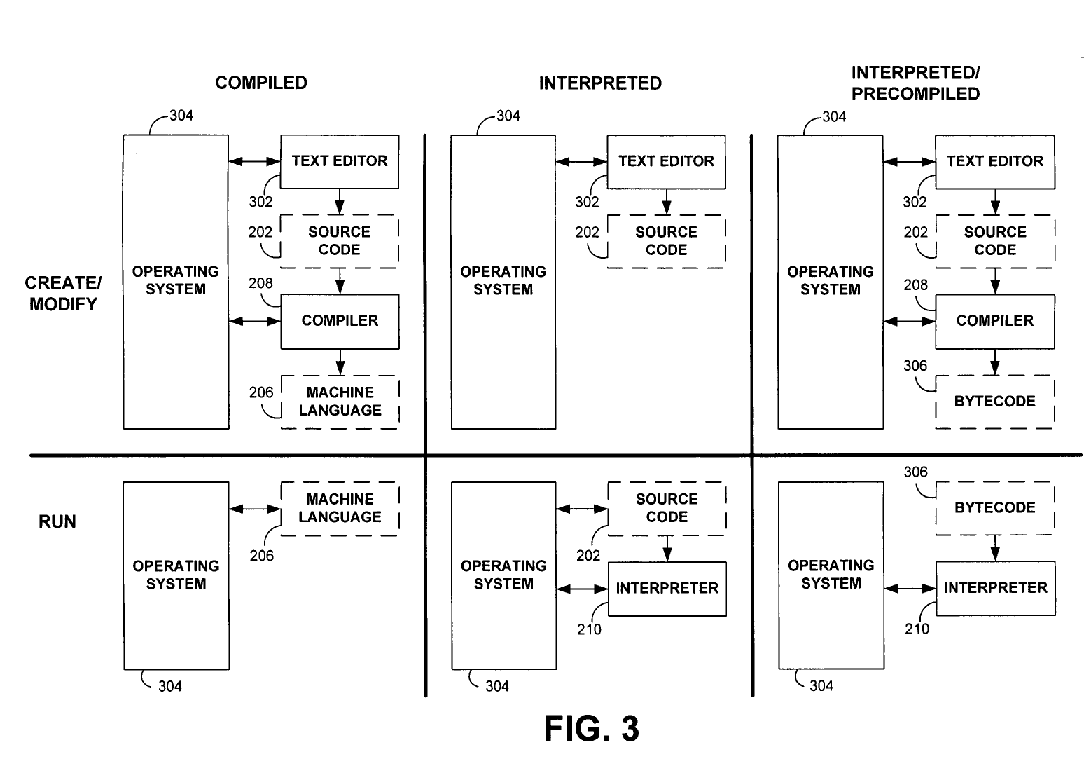

FIG. 3 is a block diagram illustrating how various types of computer code are created, modified, and run, according to an embodiment of the invention. As with FIG. 2, the various types of computer code illustrated in FIG. 3 are illustrated using dashed boxes. In FIG. 3, there are three types of computer code illustrated, including compiled code, interpreted code, and interpreted/precompiled code, each of which occupies a different vertical column in FIG. 3. In the top half of each vertical column in FIG. 3, the way that each type computer code is created and/or modified is indicated. In the bottom half of FIG. 3, the way in which each type of computer code is run is indicated.

The left-most vertical column of FIG. 3 illustrates how compiled computer code, which can include, for example, source code, is handled. As shown in FIG. 3, a text editor 302, which is in communication with an operating system (OS) 304, allows a user to create source code 202. The source code 202, once created, is converted using a compiler 208, which converts the source code 208 into machine language 206, executable on the device upon which the OS 304 is run. Because the machine language 206 created by the compiler 208 is executable on the device upon which the OS 304 is running, the OS 304 can run the machine language 206 without assistance from any other device. Examples of languages in which source code 202 that is compiled can be written include, for example, C++, Cobol, Fortran, and other similar languages.

The remaining types of computer code illustrated in FIG. 3 are interpreted code. The first type of interpreted code, shown in the center vertical column of FIG. 3, is directly interpreted computer code. Using directly interpreted computer code involves creating source code 202 (e.g., by a programmer using a text editor 302), and directly interpreting that source code 202 using an interpreter 210. The interpreted source code 202 can then be executed by the OS 304. Specifically, the interpreter 210 converts each statement of the source code 202 directly into instructions that can be executed by the OS 304 (e.g., machine language 206 instructions), prior to converting/interpreting the next statement of the source code 202. Thus, the source code 202 is not compiled, and machine language 206 for the entire source code 202 program is not created at a single time. Therefore, interpreted languages that are directly interpreted can only be executed on the machines on which they are created, or on machines using an interpreter configured similarly to the interpreter of the machine upon which the source code 202 is created. Examples languages in which source code 202 that is directly interpreted can be written include, for example, Basic, dBase, and other similar languages.

Another type of interpreted code is source code 202 that is precompiled into an intermediate form of code referred to as “bytecode” 306 as shown in the right-most vertical column of FIG. 3. Similarly to the compiled code, source code 202 that is pre-compiled prior to being interpreted is created by a programmer (e.g., using a text editor 302), and is pre-compiled using a compiler 208, which converts the source code 202 into bytecode 306. Because the bytecode 306 can be relatively generic, an interpreter 210 can be configured to interpret the general bytecode 306 on a variety of different computing platforms, such that the bytecode 306 can be executed on a number of different devices using different OSs 304 (i.e., the bytecode 306 can be platform-independent). Examples of languages in which source code 202 that is pre-compiled (e.g., into bytecode 306) and interpreted can be written include, for example, Java, Visual Basic, and other similar languages.

The computer code that is compiled (e.g., as illustrated in the left-most vertical column of FIG. 3), computer code that is interpreted (e.g., as illustrated in the center vertical column of FIG. 3), computer code that is interpreted and pre-compiled (e.g., as illustrated in the right-most vertical column of FIG. 3), and computer code illustrated in FIG. 2 are all various types of computer code that can be used in connection with one or more embodiments of the invention. Additionally, any types of computer code, including types not illustrated in FIG. 2 or FIG. 3, can be used according to one or more embodiments of the invention.

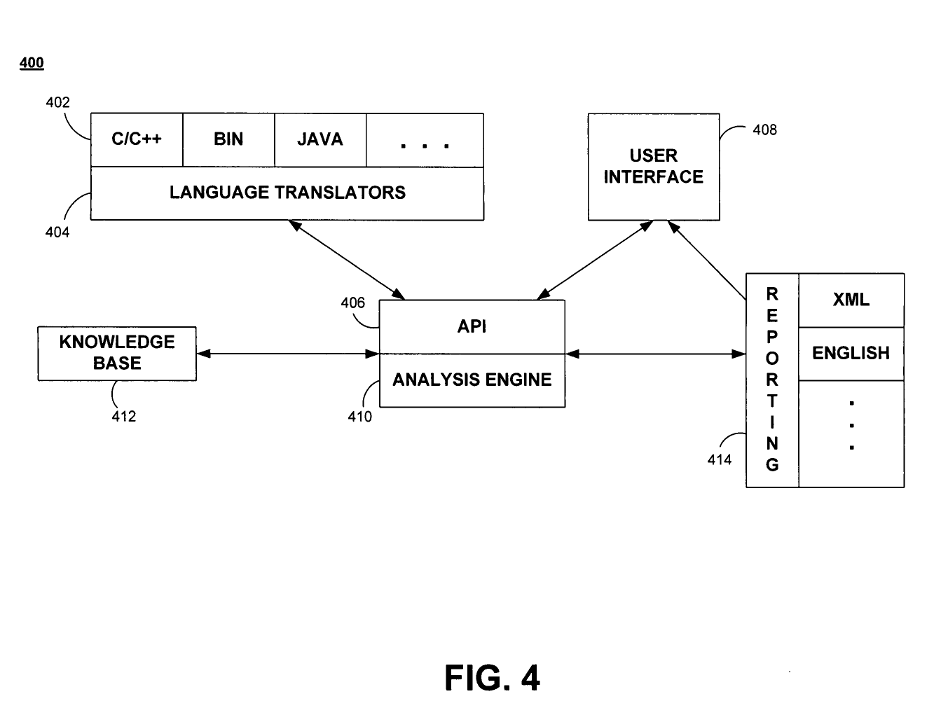

FIG. 4 is a block diagram of a system 400 for analyzing computer code, according to an embodiment of the invention. The system 400 shown in FIG. 4 includes multiple components, some of which can be optionally omitted according to one or more embodiments of the invention, depending upon the desired function of the system 400 illustrated in FIG. 4. Moreover, additional components not shown in FIG. 4 can be added to the system 400 shown in FIG. 4, as desired, depending upon the desired functionality of the system 400.

The system 400 shown in FIG. 4 analyzes a variety of different types of computer code 402, including, for example, C, C++, binary (BIN), Java, and other languages. For example, according to one or more embodiments of the invention, many other types of computer code can be analyzed using the system 400 shown in FIG. 4, including the types of computer code discussed above, or others. For example, Python, practical extraction report language (Perl), PHP hypertext preprocessor (PHP), Objective C, “.net,” and other languages can also be used with the system 400. Additionally, the various types of computer code 402 can be represented in different formats. For example, Java, which is an interpreted, pre-compiled computer code, can be represented either as source code or bytecode. Similarly, C, which is a compiled computer code, can be represented as source code, assembly language code, or machine language code.

The various types of computer codes 402 can be translated by one or more language translators 404. The language translators 404 are capable of translating each of the types of computer codes 402 into a generic computer language, which preserves the functions, instructions, and operations of the original computer code. The generic computer language can preserve the functions, instructions, and operations of the original computer code 402, while at the same time altering the specific statements or syntax of statements of that computer code. Thus, the generic language created by the language translators 404 creates a language-independent representation of multiple types of computer code 402.

According to one or more embodiments of the invention, the generic computer language can be a relatively low-level language (e.g., having low-level instructions) with high-level constructs. For example, the generic computer language can track variable names, which is a higher-level construct than is usually associated with low-level languages (e.g., assembly code or machine language). The generic computer language can include, for example, four categories of operation codes (or op codes). These four categories include: binary code (e.g., add, subtract, multiply, modulo, etc., commands), unary op code (e.g., negation, address of, complement, etc.), stack operations (e.g., push, pop, re-push, etc.), and specialized or miscellaneous op codes (e.g., exception handling, return, call, etc.). To handle op codes of the generic computer language, for example, the analysis engine 410 (discussed below) can use a jump table to define entry points associated with the generic computer language. The jump table can define a handler for each op code in the generic computer language, if desired.

Additionally, or alternatively, the language translators 404 can be used to build, or otherwise create a simulation in the generic computer language of a run of a program in the original computer code (e.g., embodied in one of multiple computer languages). This can occur, for example, by providing all of the information necessary to run a program that has been translated into a generic computer language, including information that would normally be provided by linkers, run-time libraries, and so forth.

To implement the statement x=y+42, the generic computer language might use the following instructions:

cs_op_push_variable x;
cs_op_push_variable y;
cs_op_push_signed 42;
cs_op_add;
cs op_assign;
cs_op_up;

Alternatively, to implement the same statement using a pointer (i.e., a higher-level construct), where x is a pointer to “foo,” and foo is defined takes the place of x, rendering the statement x→foo=y+42, the generic computer language might use the following instructions:

cs_op_push_variable x;
cs_op_deref;
cs_op_child foo;
cs_op_push_variable y;
cs_op_push_signed 42;
cs_op_add;
cs op_assign;
cs_op_up;

According to one or more embodiments of the invention, the language translators 404 can resolve various attributes of the computer code 402, such as names, variables, or the like. In this manner, the language translators 404 can operate as a linker 210 (shown in FIG. 2), in that the language translators 404 can resolve various names, variables, functions, and other elements, of the original computer code 402.

An application-programming interface (API) 406 can be used to communicate information between various components of the system 400. For example, the API 406 can communicate information between the language translators 404 and other components of the system 400. The language translators 404 can use the API 406 to build the generic computer language, which is translated from the original computer code 402. This can be accomplished using information internal to the API 406 or, alternatively, using information that can be accessed using the API 406 (e.g., from other components of the system 400).

The API 406 can also optionally communicate with a user interface (UI) 408, such as a graphical user interface (GUI), or other suitable UI. By way of the UI 408, a user can access various functionalities provided by the API 406. These functionalities provided by the API 406 can either be functionalities within the API 406 itself, or functionalities of other components accessed via the API 406, such as functionalities of the system 400, for example.

An analysis engine 410, which can communicate with the API 406, can be used analyze the generic computer language provided to the API 406 from the language translators 404. The analysis engine 410 can provide a variety of analysis techniques that can be performed on the generic computer language received from the language translators 404. For example, the analysis engine 410 can perform analysis techniques, such as alias analysis, control flow analysis, buffer analysis (also referred to as range analysis), integer overflow analysis, data flow analysis, or other analysis techniques. Each of the analyses performed by the analysis engine 410 can be performed beginning at one or more entry points of the generic computer language received from the language translators 404. Specifically, the analysis engine 410 can analyze the flow of data, beginning at each entry point, to determine how each function or operation handles the data being tracked, and how they affect other program elements. Additionally, the analysis engine 410 can be configured to use one or more state machines to analyze the generic computer language by storing one or more states caused by the generic computer language.

The analyses performed by the analysis engine 410 can be, for example, performed according to one or more predetermined rules. These predetermined rules can be stored by or provided by a knowledge base component 412, which acts as a repository for rules relating to multiple types of analyses performed by the analysis engine 410. Some examples of types of analyses performed by the analysis engine 410, which can be governed by predetermined rules provided by the knowledge base component 412, are discussed in greater detail below.

The knowledge base component 412 can provide the various predetermined rules formatted according to a specified syntax. Rules can be formatted in a variety of formats having different syntaxes. For example, Python scripts, or scripts in other scripting languages, can be used to express the predetermined rules for governing how certain analyses are executed by the analysis engine 410. According to one or more embodiments of the invention using scripts, the analysis engine 410 can access one or more scripts in the knowledge base component 412, which can serve as the predetermined rules for executing the desired analysis techniques within the analysis engine 410. Alternatively, a format different from a scripting language can be used as the format for the various predetermined rules of the knowledge base component 412, which can be accessed by the analysis engine 410.

The knowledge base component 412 can include, for example, various general or well-known definitions for functions, or other operations to be performed by the source code 402. For example, the knowledge base component 412 can include information, such as information that might be provided by a compiler 208 (shown in FIG. 2), an assembler 212 (shown in FIG. 2), and/or a linker 214 (shown in FIG. 2), or other common information that the language translators 404 may not be able to provide. For example, according to one or more embodiments of the invention, the knowledge base component 412 can contain information that might be contained in general reference libraries (e.g., a standard input/output library, etc.), or the like. Thus, the knowledge base component 412 can help enable the instructions within the generic computer language provided by the language translators 404.

Both the API 406 and the analysis engine 410 can communicate with the knowledge base component 412 to receive various predetermined rules stored by the knowledge base component 412. Accordingly, in addition to the analyses executed by the analysis engine 410, the various functions of the API 406 can be governed by the predetermined rules provided or stored by the knowledge base component 412. By way of the API 406, a user (e.g., using a UI 408) can optionally add or modify rules provided or stored by the knowledge base component 412, thereby altering the way in which the system 400 functions.

Although the knowledge base component is generally used to store rules, such as analysis rules, which are used by the analysis engine 410, the analysis engine 410 can also be configured to store analysis rules. For example, according to one or more embodiments of the invention, the analysis engine 410 can store more specific analysis rules (e.g., rules that are more specific to the analysis engine 410, the generic computer language, the original computer code etc.) than the rules stored by the knowledge base component 412. For example, the rules stored by the knowledge base component 412 can be of a more general nature than those stored by the analysis engine 410.

Once analysis has been performed on the generic computer language provided by the language translators 404, the analysis engine 410, or the API 406 can communicate or otherwise report information concerning the various analyses performed by the analysis engine 410 to a user. This can be accomplished, for example, using a reporting component 414 capable of communicating with the API 406 and/or the analysis engine 410. The reporting component 414 can communicate information, such as the results of one or more analyses performed by the analysis engine 410, to a user (e.g. via a UI 408, etc.), in a variety of formats.

For example, the reporting component 414 can prepare reports in English, in a mark-up language, such as an extensible mark-up language (XML) or hypertext mark-up language (HTML), or in other suitable reporting formats. Additionally, or alternatively, information provided by the reporting component 414 can be provided in other forms, such as metadata, which can be formatted to provide information such as variable information, associated problem information, and so forth. For example, in the case of a buffer overflow situation, the information that is provided using metadata can include the variable name, the size of the overflow, the size of the buffer at the time of the overflow, the allocation location for the variable, and other desirable information.

The reporting component 414 can also generate information in a form suitable for storage and later retrieval, such as a format suitable for storage in a database or other similar storage component 116 (shown in FIG. 1). This information can then later be retrieved and/or analyzed (e.g., using the analysis engine 410), as desired. For example, the reporting component 414 can use open database connectivity (ODBC), or other suitable formats, to communicate reports generated by the system 400. Additionally, the reporting component 414 can be configured to store information in a database (e.g., the storage component 116 of FIG. 1) either locally or remotely located with respect to the reporting component 414, and can access the database via a network (e.g., the network 150 of FIG. 1) if remotely located.

Additionally, or alternatively, the reporting component 414 can communicate information using a number of reporting tools. For example, various reporting tools can be used by the reporting component 414 to report information, such as overflow conditions (e.g., buffer, integer, etc.), format string information, or other useful information. Each reporting tool can be registered with the reporting component 414, and can have a list of incidents of interest associated therewith, regarding which each reporting tool generates a report via the reporting component 414. The reporting component 414 can avoid reporting duplicate information by tracking and taking into account stack traces and location information associated with an error location within the original computer code 402 or the generic computer language.

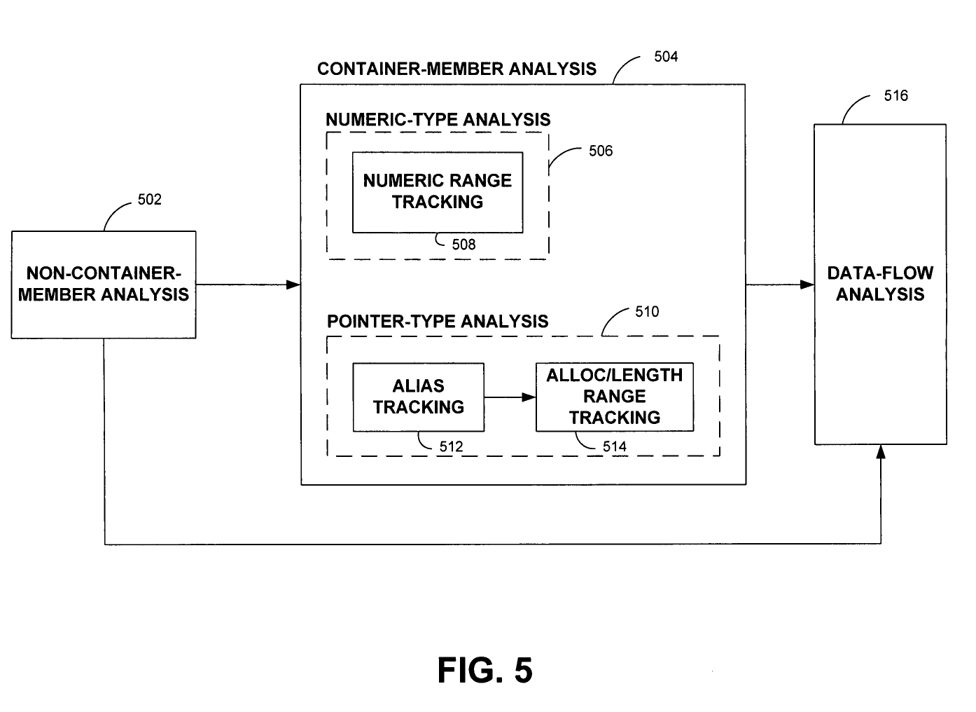

FIG. 5 is a block diagram of various analyses carried out according to an embodiment of the invention. The analyses shown in FIG. 5 can be carried out on computer code, and the various constructs or statements contained therein, as they are embodied, for example, in a generic computer language. The various analyses represented in FIG. 5 can be performed either in the order shown and described in connection with FIG. 5, or in another order suitable for providing desired results, according to one or more embodiments of the invention.

At least three basic types of elements can be analyzed using the analysis techniques illustrated in FIG. 5: scalars, pointers, and containers. Both scalars and pointers can be referred to as non-container elements, meaning that they need not be included within a container (although they can be included in a container). Scalars include, for example, integers (int), floating point numbers (float), and other simple data types. Pointers include variables that hold an address of another variable or the address of an element (e.g., the beginning) of an array of variables. Containers include more complex constructs, such as functions, structures, classes, “if-then” statements, switch-case statements, or the like, which are generally associated with high-level languages (e.g., C, C++, etc.). Each container can include one or more non-container elements, such as scalars and/or pointers. As shown in FIG. 5, analysis can be carried out on elements that are not members of a container (e.g., referred to as non-container members) using non-container-member analysis 502 and elements that are members of a container (e.g., referred to as container members) using container-member analysis 504.

A non-container-member analysis 502 can be performed on all non-container members (e.g., non-container elements that are not part of a container, such as a function, class, etc.). The non-container-member analysis 502 will vary depending on the specific non-container element being analyzed. For example, the non-container-member analysis 502 can be a numeric-type analysis 506 (described below) when non-container members of a numeric type (e.g., scalars) are being analyzed. Alternatively, the non-container-member analysis 502 can be a pointer-type analysis 510 (described below) when non-container members of a pointer type (e.g., pointers) are being analyzed.

A container-member analysis 504 can be performed for each of the container-member types (e.g., functions, classes, etc.). The container-member analysis 504 can include various analyses that can be performed on the various members of each container, which can vary according to the type of container member being analyzed. The container-member analysis 504 can include, for example, numeric-type analysis 506 and pointer-type analysis 510, for each container member of a numeric type and a pointer type, respectively. For example, the container-member analysis 504 can include a numeric-type analysis 506 to analyze each container member of a numeric type (e.g., scalars). The numeric-type analysis 506 can include, for example, a numeric-range-tracking analysis 508, or other numeric-type analysis 506, which is described in greater detail below. The numeric-type analysis 506 can be repeated for each container member of a numeric type. Additionally, the container-member analysis 504 can include a pointer-type analysis 510 to analyze each container member of a pointer type (e.g., pointers). The pointer-type analysis 510 can include, for example, an alias-tracking analysis 512 and/or an allocation- (or length-) range-tracking analysis 514, each of which is described in greater detail below. The pointer-type analysis 510 can be repeated for each container member of a pointer type.

Data-flow analysis 516 can be performed on the data from the non-container-member analysis 502 and/or the container-member analysis 504. For example, the data-flow analysis 516 can be performed on data not associated with a container (e.g., output by a non-container-member analysis 502). The data-flow analysis 516 can also, or alternatively, be performed on data associated with one or more containers (e.g., output by a container-member analysis 504). This data-flow analysis 516 can occur in a “piped” fashion as data is sequentially output by each of the other types of analysis shown in FIG. 5, or can occur after the other types of analysis shown in FIG. 5 are complete.

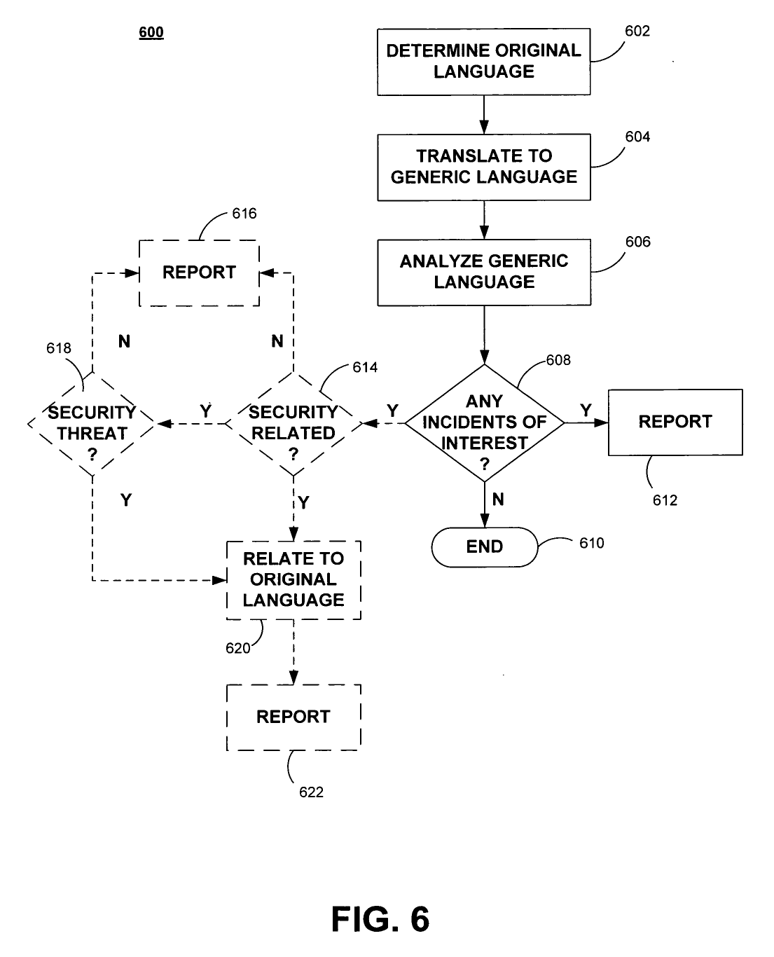

FIG. 6 is a flow diagram of a technique 600 for analyzing computer code, according to an embodiment of the invention. The technique 600 shown in FIG. 6 includes various steps and optional steps that can be performed according to one or more embodiments of the invention. It should be recognized, however, that the various steps shown in the technique 600 of FIG. 6 can be changed or omitted, or additional steps can be added, according to the specific performance desired by such a technique 600. The technique 600 starts by determining an original language of computer code (e.g., an original computer code 402, as shown in FIG. 4) in step 602. Determining the original language can include determining the type of language of the computer code (e.g., compiled, interpreted, or interpreted/pre-compiled, etc.), or determining a specific language of the computer code (e.g., C, C++, Java, binary, etc.).

Once the original language of the computer code has been determined in step 602, the original language is translated into a generic computer language in step 604. This can be accomplished, for example, using language translators 404 (shown in FIG. 4) as described above. As mentioned above, the generic computer language can be a language-independent representation of computer code. Thus, step 604 can include resolving language-specific constructs (e.g., variable names, etc.), and creating a representation of computer instructions that is generic, and independent of any specific computer language, including the original language (e.g., original source code 402) of the computer instructions being translated in step 604.

Once the language has been translated to a generic language in step 604, the generic language is analyzed in step 606. The analysis performed in step 606 can include a variety of analysis techniques, which can be performed by an analysis engine 410 (shown in FIG. 4), as described above. For example, in step 606, the generic computer language can be analyzed using alias analysis, control-flow analysis, buffer-analysis, range analysis, integer-overflow analysis, data-flow analysis, and/or other desirable analysis techniques. The analysis performed in step 606 can be, for example, performed according to one or more predetermined rules, which can be stored in or provided by a knowledge base component 412 (shown in FIG. 4). For example, according to one or more embodiments of the invention, the predetermined rules can be determined by the knowledge base component 412 in the form of special syntax, or scripts (e.g., Python scripts, etc.), or other suitable formats.

Once the generic language has been analyzed in step 606, a determination can be made in step 608 regarding whether any incidents of interest exist within the generic language. Incidents of interest can be, for example, defined within the predetermined rules of the knowledge base component 412 (shown in FIG. 4), or can be predefined by a user, or from another source. During the analysis of step 606, each time an incident of interest in encountered, it is flagged or stored for reporting later. If it is determined in step 608 that no incidents of interest exist, the technique 600 ends in step 610. If one or more incidents of interest exist, however, (e.g., previously flagged or stored), they can be reported in step 612. The reporting of step 612 can occur, for example, by way of a reporting component 414 (shown in FIG. 4), and can be presented to a user (e.g., via a user interface 408, as shown in FIG. 4). Alternatively, information reported in step 612 can be stored in a database or other suitable storage component 116 (shown in FIG. 1) using a suitable database protocol (e.g., ODBC, etc.).

Additionally, or alternatively, if it is determined in step 608 that incidents of interest exist, a determination can be made in step 614 of whether the existing incidents of interest are security-related (e.g., according to predetermined rules from the knowledge base component 412 of FIG. 4). If the incidents are determined not to be security-related, a report can be generated in step 616. On the other hand, if the incidents are determined to be security-related, an additional determination can optionally be made in step 618, regarding whether the security-related incidents of interest present a security threat. If it is determined in step 618 that no security threat exists, then a report can be generated in optional step 616. On the other hand, if the security-related incidents of interest present a security threat, as determined in step 618, then the security-related incidents of interest can be related to the original language (e.g., the original source code 402, as shown in FIG. 4) in step 620. Optionally, any security-related incident of interest determined in step 614 can be related to the original language in optional step 620. Once the security-related incidents of interest have been related to the original language in step 620, a report can be generated in 622.

Relating the security-related incidents to the original language in step 620 can include, for example, determining an instruction, a statement, or other construct that presents a security-related incident of interest within the generic computer language. Once the construct has been identified, the corresponding construct in the original language is identified. Information regarding the construct in the original language that has caused the security-related incident of interest can then be reported in optional step 622.

The reporting that of optional step 622 and optional step 616 is similar to the reporting that can occur in step 612. For example, information can be reported by way of a reporting component 414 (shown in FIG. 4), or other device. This information can, for example, be communicated to a user (e.g., via a user interface 408, as shown in FIG. 4), or can be stored in a database or other suitable storage component 116 (shown in FIG. 1). Any filtering of data, such as determinations regarding whether incidents of interest are security-related or a security threat, can be accomplished either by the analysis engine 410 or the UI 408 (shown in FIG. 4), depending upon user preferences for the system.

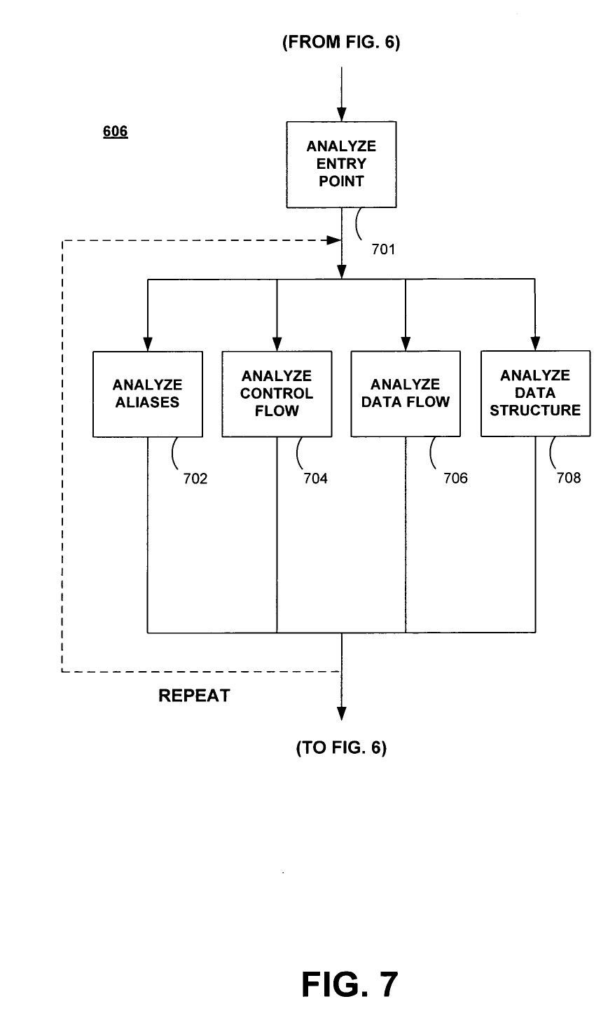

FIG. 7 is a flow diagram of a technique 606 for analyzing computer code, according to an embodiment of the invention. The technique 606 shown in FIG. 7 is an example of the analysis that can occur in step 606 of FIG. 6. Accordingly, as shown in FIG. 7, the generic language into which the original computer code has been translated (e.g., in step 604 of FIG. 6) can be analyzed using one or more of a variety of different analyses.

The technique 606 shown in FIG. 7 begins as an entry point of the generic computer language program is analyzed in step 701. In general, a program can have several entry points into the computer code of which it is comprised, in addition to the main entry point of the program. Each of these entry points (e.g., each function contained within a library that may be a part of the computer language program) can be called or executed in many different ways. It is possible, however, to discern how each entry point may be called. In such cases, the state of the processor executing the computer language program can be useful in performing the entry point analysis in step 701. In particular, the state of the processor (and associated computing environment) can be simulated at a particular point in the execution process, which will then be used to analyze that portion of code at the entry point under examination.

As is well known, each entry point begins a new process or “thread” of execution of the computer language program. Each thread can be viewed as a conditional portion of execution of the computer language program. If the thread is entered (i.e., if the function is called), the state of the processor and associated computing environment will be affected in a particular way, if the thread is not entered, the state of the processor and associated computing environment will be affected in a different way. The entry point analysis in step 701 determines such effects. In an embodiment of the invention, such an analysis based on an initial state yields much more accurate results than a “generic” inspection of the entry point (i.e., an analysis performed without simulating the state of the processor and associated computing environment).

According to one or more embodiments of the invention, specific and global functions can be analyzed. For example, each specific function within a program can be analyzed individually (e.g., using a specific-function analysis). Additionally, other constructs, such as methods, and so forth, can be treated as specific functions for the purpose of analysis, and can be analyzed individually (e.g., using specific-function analysis). Special attention can be paid to how data is transferred between the various functions, and on how the various functions interrelate and affect other aspects of the overall program. A special global function can be created and analyzed for all global variables or other global constructs. This special global function can be analyzed using a global-function analysis.

For the sake of simplification, approximations can be used for functions calling functions. For example, if a first function ƒ(a) has a range of x, x can be used in place of the first function ƒ(a) when the first function is called by a second function, g(b). This approximation requires less computation, but is slightly less accurate. However, depending on the desired analysis to be performed on the functions, such a substitution may be sufficiently accurate. For example, for a simple range analysis, using such a substitution may be sufficient for determining that the second function g(b) does not exceed a predetermined range (e.g., as specified by the knowledge base component 412 shown in FIG. 4).

Once the entry point of the generic computer language has been analyzed in step 701, one or more analysis techniques can be performed on the generic computer language, examples of which are described below in greater detail. For example, the technique 606 can include analyzing aliases 702, analyzing a control flow 704, analyzing a data flow 706, and analyzing a data structure 708. The technique 606 can optionally repeat as many times as desired, and can therefore incorporate as many of the various types of analysis illustrated in FIG. 7.

Alias Analysis

According to one or more embodiments of the invention, alias analysis can be used (e.g., in step 702 of FIG. 7) to keep track of all alias relationships within a specific computer program (e.g., as represented in the generic computer language). This can occur, for example, in response to one or more predetermined rules provided by the knowledge base component 412 (shown in FIG. 4). Alias analysis can track obvious relationships, such as explicit assignments (e.g., represented in the form of an equation, such as x=y) or implicit assignments (e.g., represented by function arguments). Additionally, alias analysis can include tracking alias relationships that are not as obvious, such as array indexing (e.g., pre/post-increment, pre/post-decrement, etc.), pointer arithmetic, addresses of variables, or the like. For example, alias analysis (e.g., as performed in step 702 of FIG. 7) can be used to track variable addresses, such as the following C/C++ language address statement:

int a,*x;
x=&a;

Control-Flow Analysis

Control-flow analysis (e.g., as performed in step 704 of FIG. 7), assists in interpreting a stream of data, can be stack-based, and can be performed by an analysis engine 410 (shown in FIG. 4), or other suitable component. Control-flow analysis follows the instructions within the generic computer language to determine the flow through the computer code represented by the generic computer language. Additionally, control-flow analysis analyzes the flow of data, and tracks that data over one or more branches of the generic computer language.

For example, in an “if-then” statement having multiple branches, such as:

if A <x>;
else <y> endif;

one way to track the flow of data is to try both alternatives (i.e., try x first and then try y). Trying both alternatives, however, can be too time-consuming. Thus, a desirable alternative technique for analyzing the flow of data over multiple branches can include evaluating each branch, saving the state of the data after each branch has been analyzed, and merging all of the saved states. Using this merging technique, the flow of data over all branches can be obtained more quickly.

For example, using control-flow analysis to merge the analysis of the sample “if-then” statement provided above would yield the following:

evaluate A;

save first state;

evaluate <x>;

save second state;

evaluate <y>;

save third state;

merge first, second, and third states;

where A, <x>, and <y> are each separately evaluated, and a state is saved after each is evaluated. Once all of the states have been saved, they are merged. Using this merging technique, the flow of data through both branches of multi-branch statements (e.g., “if-then” statements, switch-case statements, etc.) can be analyzed much more quickly than independently trying both each alternative.

The same techniques described above in connection with the sample “if-then” statement can be used in other multi-branch constructs, such as switch-case statements, or the like. Each of the multiple branches to be analyzed in such a multi-branch scenario can first be evaluated to determine if they are readable prior to evaluating, and then evaluated, or can be evaluated regardless of readability. A state can be saved for each branch that has been evaluated, and the states can be merged, once all states have been saved.

One example of a multi-branch structure in generic computer language for which control-flow analysis can be used is illustrated below. The language is shown in the left-most column, and the corresponding range at each section of the generic language is shown in the middle column. In the right-most column, the states saved, restored, and merged, using the control-flow analysis, are shown at each stage of the multi-branch structure.

| Generic Language | Range for Analysis | States |
|---|---|---|
| int x; | [none:none] | |
| x = 5; | [5:5] | Save x → [5:5] |
| if A; | [5:5] | |
| x = 1; | [1:5] | Save x → [1:5] |
| goto label | | |
| else | | Restore x → [5:5] |
| x = 17; | [5:17] | Save x → [5:17] |
| endif | | Merge x → [1:17] |

In the example shown above, the first branch (“if A”) results in a first range of [1:5] being saved after the first “if” branch of the multi-branch structure. The original range of [5:5], which corresponds to the initialization value of x is restored, and the second branch (“else”) results in a second range of [5:17] being saved. After states for each branch of a multi-branch structure have been saved (e.g., when the “endif” statement is reached), the ranges can be merged, such as merging the first range [1:5] and the second range [5:17] into a union, merged range of [1:17].

The italicized instruction “goto label” is an example of an instruction that can cause the sample “if-then” statement shown above to be exited such that the “endif” statement may never be reached. Thus, if the “if-then” statement is analyzed by stepping through the code, it is possible that the “endif” statement will never be reached, and the range of values of the variables used in the statement may not be clear. Thus, by individually analyzing each branch of a multi-branch structure, and merging the result, one or more embodiments of the invention can avoid problems that can be experienced by approaches that step through the multi-branch code. Additionally, the control-flow analysis can, upon reaching an instruction that causes the “if-then” statement to be exited, continue to execute the generic computer language until the end of a function is reached (e.g., a “return” statement is reached), and/or until a convergence of instructions is reached (e.g., both branches reach the same level).

Control-flow analysis of pointers is performed in a similar manner as described above. In handling pointer analysis, the highest and lowest values of the pointer can be handled as integers.

| Generic Language | Allocation | Length |
|---|---|---|
| x = malloc(42) | [42:42] | [none:none] |
| Strcpy (X, “hello”); | [42:42] | [6:6] |
| X[42] = 17; | [42:42] | [6:43] |

Using the control-flow analysis on a pointer, as shown above, allows the memory allocation and length to be tracked. When a length range exceeds the allocation range of the declared variable x, an overflow condition can be identified and reported, if necessary. This type of analysis can also be referred to as allocation-range tracking 514 (shown in FIG. 4).
Data-Flow Analysis

Data-flow analysis (e.g., as performed in step 706 of FIG. 7, or as illustrated in FIG. 5), can be executed using scripts (e.g., Python scripts, etc.), and can be performed by the analysis engine 410 (shown in FIG. 4), or other suitable component. Data-flow analysis is similar to alias analysis (discussed above), because it tracks the flow of data in the computer code (i.e., in the generic computer language). Data-flow analysis, however, determines whether data is able to propagate to a particular point, and whether multiple data flows between two points within a program exists simultaneously with overlapping control of the data. If data flows between two points and overlapping control of the data exists simultaneously, a potential security risk exists for that data. For example, if a variable is created or verified at a certain point within the program and, prior to being used, other manipulation of the data occurs, there is a potential security risk that before the variable can be used, it can be changed.

For example, consider the scenario illustrated below where, after checking the value of the variable x and determining that it is a first value (A), operations of the generic computer language change that value to a second value (B) prior to use of the variable x.

| Generic Language | Value |
|---|---|
| check (x); | x = A |
| . . . | |
| operate on x; | x = B |
| . . . | |
| use (x); | x = B |

Thus, as the data (e.g., the variable x) flows in the generic computer language from the first point (e.g., where the variable is checked) to a second point (e.g., where the variable is used) there is overlapping control of the data (e.g., the data can be operated on). This situation can cause a possible discrepancy in the assumed value of the variable, which can be an incident of interest (e.g., the discrepancy can cause security-related problems, data-integrity-related problems, etc.). Thus, data-flow analysis monitors the existence of such possibilities, and reports their existence (e.g., via the reporting component 414 shown in FIG. 4), if desired.
Data-Structure Analysis

Data-structure analysis (e.g., as performed in step 708 of FIG. 7) includes analysis of one or more of various data constructs, such as programs, types, functions, variables, locations, op streams, opt constructs (used within op streams), or the like. Data-structure analysis can include analysis of each of these types of constructs within a generic computer language program. Additionally, special attention can be paid to entry point functions and external variables, for security purposes, which can allow unintentional or undesirable external access to such computer programs.

The top-level of a data-structure analysis can include, for example, an analysis of an entire computer program (e.g., cs_program_t). This can include an analysis of the functions, types, variables, special global functions, entry point functions, and/or external variables of the program. Within a program, entry point functions and external variables can be particularly scrutinized. For example, entry point functions provide access to the program by external programs or devices. Additionally, external variables, which are received into the program from external sources, can pose security risks if they are declared but not assigned because such a situation would leave the assignment of these variables to external forces, which cannot be controlled, thereby creating an incident of interest, or a potential security risk.

According to one or more embodiments of the invention, various constructs and data types within the program can be analyzed (e.g., cs_type_t) using data-structure analysis. For example, arrays, containers, object-oriented constructs (e.g., classes, etc.), or the like can be analyzed as types using data-structure analysis. Information analyzed as types using data-structure analysis can include, for example, variables, name information, flags (e.g., scoping modifiers, heap versus stack allocation of memory, data tainted by outside input, etc.), base types (e.g., integers, strings, array containers, structures, classes, unions, objects, etc.), sizes, and so forth. For numeric types, a minimum and maximum value can be analyzed. For example, to analyze arrays using data-structure analysis, a subsize and/or subtype can be analyzed. For various types of containers, numerous fields can be analyzed. For computer code originally embodied in object-orientated languages, methods, ancestors, descendants, and other object-oriented structures can be analyzed. For example, according to one or more embodiments of the invention, direct ancestors (e.g., a parent), and all descendants (e.g., children) of an object-oriented type (e.g., a class) can be analyzed using data-structure analysis.

Data-structure analysis can be used to analyze variables (e.g., cs_variable_t). For example, data-structure analysis can analyze the name, type, parent, child/children, location, address, or other elements of a variable. If the variable is a pointer, that information can be identified in the type associated with the variable. Data-structure analysis can also be used to analyze location information (e.g., cs_location_t). For example, data-structure analysis can be used to analyze elements such as block information, function information, file name information, and line number information associated with the location of an element being analyzed using data-structure analysis

Data-structure analysis can also be used to analyze information relating to specific functions (e.g., cs_function_t). For example, data-structure analysis can be used to analyze names, types, parameters, op streams (e.g., all instructions that make up a function), locations, variables, and other information relating to functions. Data-structure analysis can also be used to analyze op stream information (e.g., cs_opstreamblock_t). For example, data-structure analysis can be used to analyze head information, tail information, first information, and last information, associated with an op stream.

Additionally, within each op stream, data-structure analysis can be used to analyze each opt construct (e.g., cs_op_t, within each cs_opstreamblock_t), or stack operation within each op stream. For example, data-structure analysis can be used to analyze location information and op code (e.g., machine language) information for each op stream. For example, each op code that is analyzed using data-structure analysis can be analyzed as a wrapper defining what data it will take from and leave on the stack, and the operation that it will perform on that data.

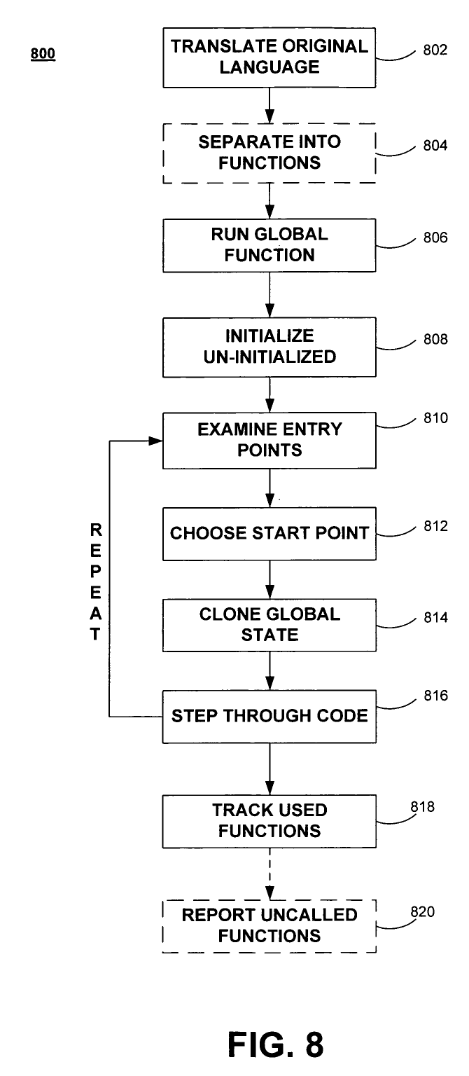

FIG. 8 is a flow diagram of a technique 800 for analyzing computer code, according to an embodiment of the invention. The technique 800 shown in FIG. 8 analyzes computer code, which can be represented in a variety of formats, and/or languages. In step 802 the original language of the computer code is translated into a generic computer language. The generic computer language is independent of any original computer language (e.g., source code, etc.), and preserves the general instructions of the original language from which it is translated. As described above, the translation of step 802 can be performed, for example, using language translators 404 (shown in FIG. 4).

Once the original language has been translated into a generic computer language in step 802, the generic computer language can optionally be separated into multiple functions in optional step 804. It should be recognized that optional step 804 is not required for certain implementations of the invention. For example, if the original language is binary, and no functions exist, then there would be no need to separate the translated language into functions, and thus no need for optional step 804.

A global function, which accounts for all of the global variables and other global constructs can be run in step 806. Each of the global variables and global constructs (e.g., variables that are declared as global) are analyzed, and in step 808, each of the global constructs that has been declared as global, but which is un-initialized, is initialized with an infinite range. By initializing these global constructs with an infinite range, it can be determined whether the fact that they are un-initialized presents an incident of interest, such as a potential security or other concern (e.g., buffer overflow, etc.).

In step 810, each of the entry points to the global function is analyzed. According to one or more embodiments of the invention, each of the entry points examined in step 810 can be marked at the time of translation in step 802 (e.g., by way of language translators 404, as shown in FIG. 4). Such marking of entry points can be accomplished, for example, based on information stored in a knowledge base component 412 (shown in FIG. 4). After examining each of the entry points in step 810, a starting point is chosen in step 812, whereby one of the entry points is selected as the first entry point for which analysis will be conducted.

Prior to conducting any analysis, the global state can be cloned in step 814 to preserve the original global state prior to performing any analysis. The computer code (e.g., as expressed in the generic computer language) is stepped through in step 816, and one or more analysis techniques described above (e.g., alias analysis, control-flow analysis, data-flow analysis, data-structure analysis, etc.) can be performed on the computer code, as desired.

Steps 810, 812, 814, and 816 are repeated for each of the entry points. Each time the code is stepped through in step 816 for another entry point, the functions (or other constructs) that have been used can be tracked (e.g., by incrementing a value, by setting a flag, etc.) in step 818. After the code has been stepped through for each entry point, and each of the program's various functions have been tracked in step 818, the uncalled functions can optionally be reported in step 820. This can occur, for example, by way of a reporting component 414 (shown in FIG. 4), or by another suitable mechanism. Additionally, one or more of the analysis techniques described above can be performed on the uncalled functions reported in optional step 820, as desired.

From the foregoing, it can be seen that systems and methods for analyzing computer code are discussed. Specific embodiments have been described above in connection with specific analysis techniques, and specific components of a system for analyzing computer code.

It will be appreciated, however, that embodiments of the invention can be in other specific forms without departing from the spirit or essential characteristics thereof. For example, while specific analysis techniques and components of systems have been described above, those analysis techniques and/or components can be varied depending upon their desired functionality according to one or more embodiments of the invention for analyzing computer code. Additionally, the specific systems, devices, methods, and techniques described above used to implement one or more embodiments of the invention can be varied according to their desired functionalities or capabilities.

The presently disclosed embodiments are, therefore, considered in all respects to be illustrative and not restrictive.

What is claimed is:

1. A system, comprising:
a translator configured to translate code including code from one of a plurality of computer languages to a generic computer language, the generic computer language maintaining the instructions of the code;
a knowledge base component configured to store a plurality of analysis rules associated with analysis of code in the generic computer language;
an analysis engine in communication with the language translator and the knowledge base component, the analysis engine being configured to analyze code in the generic computer language received from the translator according to one or more rules stored by the knowledge base component, the analysis engine being further configured to output any incidents of interest required to be reported by the one or more rules; and
a reporting component in communication with the analysis engine, the reporting component being configured to report any incidents of interest output by the analysis engine in a form readily accessible by a user.

2. The system of claim 1, wherein the translator is further configured to build a simulation in the generic computer language of a run of a program in one of the plurality of computer languages.

3. The system of claim 1, wherein the analysis engine is further configured to store additional analysis rules, the knowledge base component being configured to store a plurality of analysis rules of a more general nature than the additional analysis rules.

4. The system of claim 1, wherein the analysis engine and the knowledge base component are configured to store rules in the form of at least one script.

5. The system of claim 1, wherein the analysis engine is configured to use at least one state machine to analyze the code in the generic computer language.

6. The system of claim 1, wherein the reporting component is configured to report using a mark-up language format.

7. The system of claim 1, wherein the reporting component is configured to interface with a database via a network.

8. The system of claim 1, wherein the analysis engine is configured to analyze aliases contained in the code in the generic computer language.

9. The system of claim 1, wherein the analysis engine is configured to analyze a control flow of the code in the generic computer language.

10. The system of claim 1, wherein the analysis engine is configured to analyze a data flow of the code in the generic computer language.

11. The system of claim 1, wherein the analysis engine is configured to analyze a data structure of the code in the generic computer language.

12. The system of claim 1, wherein the analysis engine is configured to analyze a special global function within the generic computer language.

13. The system of claim 1, wherein the analysis engine is configured to analyze a plurality of container members in the code in the generic computer language.

14. The system of claim 1, wherein the translator is configured to handle computer code in a plurality of computer languages substantially simultaneously.

15. A method, comprising:
determining an original language of a computer code, the original language being from a plurality of computer languages;
translating the computer code to a generic computer language, the generic computer language maintaining the instructions of the computer code; and
analyzing the generic language according to one or more pre-determined rules to determine if any incidents of interest exist within the computer code.

16. The method of claim 15, further comprising:
reporting any incidents of interest that exist within the computer code to a user.

17. The method of claim 15, further comprising:
reporting any incidents of interest that exist within the computer code to a user via a communication using a mark-up language format.

18. The method of claim 15, wherein the analyzing includes:
determining if an incident of interest is security related.

19. The method of claim 15, further comprising:
determining if an incident of interest is security related; and
relating the incident of interest that exists within the computer code to the original language, if it is determined that the incident of interest is security related.

20. The method of claim 15, further comprising:
determining if an incident of interest is security related; and
reporting the incident of interest to a user, if it is determined that the incident of interest is security related.

21. The method of claim 15, wherein the analyzing includes:
determining if an incident of interest is security related; and
determining if the incident of interest is a threat to security, if it is determined that the incident of interest is security related.

22. The method of claim 15, wherein the translating includes building a simulation in the generic computer language of a run of a program in one of the plurality of computer languages.

23. The method of claim 15, wherein the predetermined rules include rules specific to the computer language and general rules.

24. The method of claim 15, wherein the predetermined rules include at least one script.

25. The method of claim 15, wherein the predetermined rules include at least one state machine.

26. The method of claim 15, wherein the analyzing includes:
analyzing aliases contained in the code.

27. The method of claim 15, wherein the analyzing includes:
analyzing a control flow of the code.

28. The method of claim 15, wherein the analyzing includes:
analyzing a data flow of the code.

29. The method of claim 15, wherein the analyzing includes:
analyzing a data structure analysis contained in the code.

30. The method of claim 15, wherein the analyzing includes:
analyzing a plurality of container members in the code.

31. The method of claim 15, wherein the analyzing includes:
analyzing a special global function.

32. The method of claim 15, wherein the translating includes:
translating computer code in a plurality of computer languages substantially simultaneously.

33. A processor-readable medium comprising code representing instructions to cause a processor to:
determine an original language of a computer code, the original language being from a plurality of computer languages;
translate the computer code to a generic computer language, the generic computer language maintaining the instructions of the computer code; and
analyze the generic language according to one or more pre-determined rules to determine if any incidents of interest exist within the computer code.

34. The processor-readable medium of claim 33, further comprising code representing instructions to cause a processor to:
report any incidents of interest that exist within the computer code to a user.

35. The processor-readable medium of claim 33, further comprising code representing instructions to cause a processor to:
report any incidents of interest that exist within the computer code to a user via a communication using a mark-up language format.

36. The processor-readable medium of claim 33, further comprising code representing instructions to cause a processor to:
determine if an incident of interest is security related.

37. The processor-readable medium of claim 33, further comprising code representing instructions to cause a processor to:
determine if an incident of interest is security related; and
relate an incident of interest that exists within the computer code to the original language, if it is determined that the incident of interest is security related.

38. The processor-readable medium of claim 33, further comprising code representing instructions to cause a processor to:
determine if an incident of interest is security related; and
report the incident of interest to a user, if it is determined that the incident of interest is security related.

39. The processor-readable medium of claim 33, further comprising code representing instructions to cause a processor to:
determine if an incident of interest is security related; and
determine if the incident of interest is a threat to security, if it is determined that the incident of interest is security related.

40. The processor-readable medium of claim 33, wherein the code representing instructions to cause a processor to translate includes code representing instructions to cause a processor to build a simulation in the generic computer language of a run of a program in one of the plurality of computer languages.

41. The processor-readable medium of claim 33, wherein the predetermined rules include rules specific to the computer code and general rules.

42. The processor-readable medium of claim 33, wherein the predetermined rules include at least one script.

43. The processor-readable medium of claim 33, wherein the predetermined rules include at least one state machine.

44. The processor-readable medium of claim 33, wherein the code representing instructions to cause a processor to analyze includes code representing instructions to cause a processor to:
analyze aliases contained in the code.

45. The processor-readable medium of claim 33, wherein the code representing instructions to cause a processor to analyze includes code representing instructions to cause a processor to:
analyze a control flow of the code.

46. The processor-readable medium of claim 33, wherein the code representing instructions to cause a processor to analyze includes code representing instructions to cause a processor to:
analyze a data flow of the code.

47. The processor-readable medium of claim 33, wherein the code representing instructions to cause a processor to analyze includes code representing instructions to cause a processor to:
analyze a data structure analysis contained in the code.

48. The processor-readable medium of claim 33, wherein the code representing instructions to cause a processor to analyze includes code representing instructions to cause a processor to:
analyze a plurality of container members in the code.

49. The processor-readable medium of claim 33, wherein the code representing instructions to cause a processor to analyze includes code representing instructions to cause a processor to:
analyze a special global function.

50. The processor-readable medium of claim 33, wherein the code representing instructions to cause a processor to translate includes code representing instructions to cause a processor to:
translate computer code in a plurality of computer languages substantially simultaneously.
